(19) United States
(12) Patent Application Publication
(10) Pub. No.: US 2022/0207168 A1
(43) Pub. Date: Jun. 30, 2022

(54) IDENTIFYING AND ENABLING LEVELS OF DATASET ACCESS

(71) Applicant: Capital One Services, LLC, McLean, VA (US)

(72) Inventors: Jacob OSBORNE, Henrico, VA (US); Patricia BRYANT, Goochland, VA (US); Thomas L. ORR, Powhatan, VA (US); Charles David DUERSON, Glen Allen, VA (US); Andrew LAKOFF, Glen Allen, VA (US); Michelle BETANCOURT, McLean, VA (US)

(73) Assignee: Capital One Services, LLC, McLean, VA (US)

(21) Appl. No.: 17/138,220

(22) Filed: Dec. 30, 2020

(51) Int. Cl. G06F 21/62; G06F 21/36

(52) U.S. Cl. CPC G06F 21/6218; G06F 21/36; G06F 21/629

(57) ABSTRACT

Various embodiments described herein are generally directed to techniques for providing a user access to at least one dataset in a database. Embodiments may include using a database controller informed by information about a user to provide the user with access to a database. In some embodiments, a database controller may determine information about a user based upon identification of a user login. Aspects of information about a user account may include information about an associated user's level of ability, authorization, and/or permission to access and/or interact with the database and/or a dataset therein. Various embodiments may include adjusting a user account's access to a database and/or the presentation of the database via a user interface according to the information about the user account known to a database controller. In some embodiments, records of a user's access of a database may be recorded and maintained.

### BACKGROUND

A database is an organized collection of data, generally stored and accessed electronically from a computer system. A database management system (DBMS) may be a software that interacts with end users, applications, and the database itself to capture and analyze the data. Relational databases may be used to present data to a user including relations between data points, for example, as in a table with rows and columns. Operators may be used to manipulate a database's presentation of data to a user. For example, operators may take the form of structured query language (SQL) and be used to query and maintain a database. In order to use a database, users must therefore be enabled to use such operators to access data stored in a database. For example, a user may be required to know SQL in order to use a database.

### SUMMARY

Various embodiments described herein may include an apparatus, a device, a method, and so forth including a memory to store instructions, and processing circuitry, coupled with the memory. In some embodiments, an apparatus may comprise a processor and memory comprising instructions that are configured to be executed by the processor to cause the processor to identify a login of a registered user based on receipt of credentials correlated with the registered user. In some embodiments, the instructions may be further configured to cause the processor to retrieve profile data for the registered user based on the credentials correlated with the registered user, wherein the profile data may comprise a database ability level, one or more permission levels, and one or more authorizations. Aspects of the instructions may be further configured to cause the processor to select a user experience for the registered user based on the database ability level in the profile data retrieved for the registered user and format a graphical user interface (GUI) for the registered user based on the user experience selected for the registered user. In various embodiments, the instructions may be further configured to cause the processor to identify an access request for a dataset located in a schema of a database, wherein the database may be divided into a plurality of schemas, and wherein the access request may comprise schema credentials and dataset credentials. Aspects of the schema credentials may indicate the schema of the database, and aspects of the dataset credentials may indicate the dataset in the schema of the database. In some embodiments, the instructions may be further configured to cause the processor to retrieve one or more schema requirements based on the schema credentials and one or more dataset requirements based on the dataset credentials. In embodiments, the instructions may be further configured to cause the processor to verify the registered user is authorized to access the schema of the database based on the schema requirements and the one or more authorizations in the profile data. In various embodiments, the instructions may be further configured to cause the processor to verify the registered user is authorized to access the dataset in the schema of the database based on the dataset requirements and the one or more authorizations in the profile data. In some embodiments, the instructions may be further configured to cause the processor to determine a permission level for the registered user to access the dataset based on the one or more permission levels in the profile data, the permission level for the registered user to access the dataset comprising one or more of read access and write access. In various embodiments, the instructions may be further configured to cause the processor to provide the registered user with access to the dataset via the GUI according to the permission level for the registered user to access the dataset.

Various embodiments described herein may include at least one non-transitory computer-readable medium comprising a set of instructions that, in response to being executed by a processor circuit, cause the processor circuit to identify a login of a registered user based on receipt of credentials correlated with the registered user. In some embodiments, the set of instructions may, in response to being executed by a processor circuit, cause the processor circuit to retrieve profile data for the registered user based on receipt of credentials correlated with the registered user, wherein aspects of the profile data may comprise one or more permission levels and one or more authorizations. In some embodiments, the set of instructions may, in response to being executed by a processor circuit, cause the processor circuit to identify an access request for a dataset located in a schema of a database, wherein the database may be divided into a plurality of schemas, with aspects of the access request comprising schema credentials and dataset credentials, wherein the schema credentials indicate the schema of the database and the dataset credentials indicate the dataset in the schema of the database. In various embodiments, the set of instructions may, in response to being executed by a processor circuit, cause the processor circuit to retrieve one or more schema requirements based on the schema credentials and one or more dataset requirements based on the dataset credentials. In some embodiments, the set of instructions may, in response to being executed by a processor circuit, cause the processor circuit to verify the registered user is authorized to access the schema of the database based on the schema requirements and the one or more authorizations in the profile data, and in some embodiments, the set of instructions may, in response to being executed by a processor circuit, cause the processor circuit to verify the registered user is authorized to access the dataset in the schema of the database based on the dataset requirements and the one or more authorizations in the profile data. In various embodiments, the set of instructions may, in response to being executed by a processor circuit, cause the processor circuit to determine a permission level for the registered user to access the dataset based on the one or more permission levels in the profile data, the permission level for the registered user to access the dataset comprising one or more of read access and write access. In some embodiments, the set of instructions may, in response to being executed by a processor circuit, cause the processor circuit to provide the registered user with access to the dataset via a graphical user interface (GUI) according to the permission level for the registered user to access the dataset.

Various embodiments described herein may include a computer-implemented method, comprising retrieving profile data for a registered user based on credentials correlated with the registered user, wherein the profile data may comprise a database ability level, one or more permission levels, and one or more authorizations. Some embodiments described herein include a method further comprising selecting a user experience for the registered user based on the database ability level in the profile data retrieved for the registered user and formatting a graphical user interface (GUI) for the registered user based on the user experience selected for the registered user. In some embodiments, the method may further comprise identifying an access request for a dataset located in a schema of a database, wherein database may be divided into a plurality of schemas, and the access request may comprise schema credentials and dataset credentials, wherein aspects of the schema credentials indicate the schema of the database and aspects of the dataset credentials indicate the dataset in the schema of the database. Various embodiments described herein include a method further comprising retrieving one or more schema requirements based on the schema credentials and one or more dataset requirements based on the dataset credentials and verifying the registered user is authorized to access the schema of the database based on the schema requirements and the one or more authorizations in the profile data. In some embodiments, the method may further comprise verifying the registered user is authorized to access the dataset in the schema of the database based on the dataset requirements and the one or more authorizations in the profile data. In embodiments, the method may further comprise determining a permission level for the registered user to access the dataset based on the one or more permission levels in the profile data, the permission level for the registered user to access the dataset comprising one or more of read access and write access. In various embodiments, the method may further comprise providing the registered user with access to the dataset via the GUI according to the permission level for the registered user to access the dataset.

With such an arrangement, a system and method are provided for providing access to a dataset according to various ability, authorization, and/or permission levels.

### BRIEF DESCRIPTION OF THE DRAWINGS

FIG. 1 illustrates exemplary aspects of a system flow according to one or more embodiments described herein.

FIG. 2 is a detailed block diagram illustrating exemplary components that may be used according to one or more embodiments described herein.

FIGS. 3A and 3B are a detailed block diagrams illustrating exemplary components that may be used according to one or more embodiments described herein.

FIGS. 4A-4I illustrate exemplary aspects of a graphical user interface that may be used according to one or more embodiments described herein.

FIGS. 5A-1 and 5A-2 illustrate a first logic flow provided to describe exemplary steps that may be performed according to one or more embodiments described herein.

FIG. 5B illustrates a second logic flow provided to describe exemplary steps that may be performed according to one or more embodiments described herein.

FIGS. 5C-1 and 5C-2 illustrate a third logic flow provided to describe exemplary steps that may be performed according to one or more embodiments described herein.

FIG. 6 illustrates an embodiment of a computing architecture according to one or more embodiments described herein.

FIG. 7 illustrates an embodiment of a communications architecture according to one or more embodiments described herein.

### DETAILED DESCRIPTION

Various embodiments described herein are generally directed to techniques for providing a user access to at least one dataset in a database. Embodiments may include using a database controller informed by information about a user to provide the user with access to a database. In some embodiments, a database controller may determine information about a user based upon identification of a user login. Aspects of information about a user account may include information about an associated user's level of ability, authorization, and/or permission to access and/or interact with the database and/or a dataset therein. Various embodiments may include adjusting a user account's access to a database and/or the presentation of the database via a user interface according to the information about the user account known to a database controller. In some embodiments, records of a user's access of a database may be recorded and maintained.

Various datasets may be maintained electronically. In some cases, datasets may be maintained in the form of a digital spreadsheet or database. Spreadsheets and/or databases may be located on a local machine, such as a server or desktop computer, for example, and they may be available to one or more users. In some cases, spreadsheets and/or databases may be remote and available to at least one user via a network connection. Network connections as described herein will be understood to comprise wired and/or wireless network connections. At least one user may have access to a spreadsheet and/or database via a link, access to a website, software platform, or method otherwise known in the art.

Spreadsheets may comprise digital simulations of a paper worksheet in which nonrelational data may be tabulated. While some software platforms for generating spreadsheets may include tools for visualizing and/or performing basic calculations, these features are limited to the visualization and/or manipulation only in the open table of data. Representations of relationships between various data pieces may need to be displayed in discreet, unconnected tables, which may result in duplicative storage and/or disjointed formatting. Finding data satisfying a number of complex conditions, then, may be an inefficient operation comprising having a user open up a number of tables, perform a number of searches, and manually compile the data. Repeated such searches take an unacceptable toll of user time and effort. Additionally, adding data may require manually entering data points into as many tables as are helpful in capturing dependencies on other variables and/or data pieces.

More complex data may require storage in collections of data better suited than spreadsheets for quick access and/or complex queries. Accordingly, relational data may be stored in at least one database. Databases may store data in records of tables and allow for natural addition of further records. As a result, databases may be scalable as additional data is collected and/or new relationships between data are defined. Additionally, databases may allow multiple tables to be related and/or jointly accessible.

However, databases may present significant drawbacks. Formatting and/or visualization of data may be difficult, for example, as a result of the use of a plurality of tables. Not all features found in spreadsheet applications, such as analytical tools, are available in database applications. Furthermore, the complex operations that allow for effective access and/or manipulation of data in databases may not be intuitive for inexperienced users. In many cases, specialized training and/or knowledge may be required to use a database, for example, knowledge of programming languages. An untrained user needing to access particular data, then, may be unable to do so.

Additionally, databases may contain data an excess of data beyond what a user is immediately interested in accessing. As databases may be used to capture a number of relationships between single datapoint and other variables, some of those other variables may be unrelated to the purpose of the user's query. In some cases, such extraneous data may comprise private and/or privileged information. However, databases may be widely available to any user needing access to a subset of the data within. This may result in unnecessary security risks in which sensitive information may be accessed by unauthorized users and/or user accounts.

Furthermore, some spreadsheets and/or databases may be accessed by a plurality of users. As complexity of datasets increases, it may be more difficult to track changes to and/or access of particular data by specific users. This may negate the reliability of data sets that are already maintained by great effort, at best creating a frustrating user experience and at worst resulting in a faulty foundation for further operations depending on data.

Accordingly, there is a need for a dynamic system which may provide regulated tracking and/or access to data by a user according to their security clearance, customized functionality according to their needs, and/or specific interface experiences according to their skill level. Embodiments described herein include components that can enable one or more of these advantages. Particularly, various embodiments include a secure single sign on (SSO) web application that allows users to collect, manipulate, and view data stored on a database. In some embodiments, a web application graphical user interface (GUI) may be integrated with a database, for example, a PostgreSQL database. In various embodiments, access to a dataset may be adapted to a particular user to provide a more spreadsheet-like or relational database-like experience according to user permission levels. Aspects of some embodiments may enable preset permissions to be set for individual data sheets, for example, read, write, and admin roles. Various embodiments may include an option to populate analytical graphs and present them to users requested by the author. Some embodiments may enable validation of data in real-time and/or near real-time by connections to external databases. Various embodiments may enable a single data store to be accessible by automated processes and other data sheets. In some embodiments, users unfamiliar with programming languages often used in association with relational databases, for example, SQL, may be enabled to generate projects which carry benefits associated with relational databases.

Components described herein will provide authorized, traceable, customized access to database systems, thereby improving security, reliability, ease of use, and efficiency in user access to data. Accordingly, in various embodiments described herein, customized database access may be implemented in a practical application to increase capabilities of data access systems as a whole. For example, embodiments may be used to minimize duplication of data and efforts, and/or streamline access of altered data for automated processes. Additionally, or alternatively, human error may be minimized by embodiments which provide easy review of changes and/or which provide complete or partial restrictions of data. Embodiments may provide a unified interface for analytical and/or audit data presentation. Some embodiments may increase productivity of use of database systems by enabling user participation in data projects which may have previously required in-depth knowledge or skills. By providing a single interface through which users may interact with datasets, various embodiments may minimize the number of programs and/or tools that a user may need a license and/or installation of. In some embodiments, changes to a dataset may be recorded in a comprehensive history, for example, in association with the user who made them. Various embodiments may enable recovery of previous versions of datasets after at least one change has been made.

In various embodiments, one or more of the components, techniques, or aspects described herein may be implemented via one or more computing devices, resulting in increased capability and improved functioning of the computer devices. Specific and particular manners of determining access to datasets according to user permissions, customizing a user interface according to user experience, providing insight into the history of a dataset via a record of changes, and/or validating data via system integration with external databases may be provided by the components described in various embodiments herein. In several embodiments, expected behaviors and behaviors involving the update and management of datasets may be performed independently of software utilizing the database management via familiar, user-friendly interface objects.

In various embodiments, components, techniques, or aspects described herein may be implemented as a set of rules that improve computer-related technology by allowing a function not previously performable by a computer that enables an improved technological result to be achieved. For example, enabling use of a database by customizing a user interface according to a user's skill set may be an improved technological result.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form to facilitate a description thereof. The intention is to cover all modification, equivalents, and alternatives within the scope of the claims.

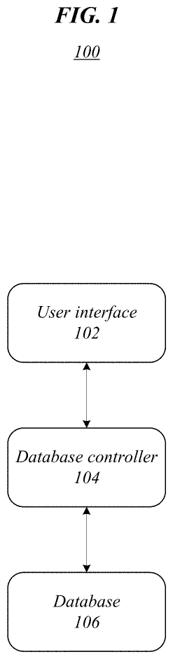

FIG. 1 illustrates exemplary aspects of a system flow according to one or more embodiments described herein. The system flow 100 may include a user interface 102, a database controller 104, and a database 106. Aspects of system flow 100 described herein may comprise a processing system that includes one or more computing devices that are interconnected via one or more network links, e.g., wired, wireless, fiber, etc. In some embodiments, aspects may comprise a distributed computing system with each server comprising one or more cores to process information and data. Embodiments are not limited in this context.

A user interface 102 may be used to access a database 106 by using a database controller 104. The database controller 104 may be used to manipulate the user interface 102, and/or aspects of a database 106 may be used to inform a database controller 104. Greater detail according to various embodiments is described below.

The user interface 102 may be configured to receive input, for example, from a user. In embodiments, the user interface 102 may be operable via an input device, for example, a mouse, keyboard, and/or other input device known in the art. In various embodiments, the user interface 102 may be an application, software, or other GUI displayed on a computer, for example, a desktop computer or a laptop. In various embodiments, the user interface 102 may be available via a network connection, for example, as a part of a web application.

In various embodiments, log in information may be received via the user interface 102 or otherwise access the interface according to a log in of a coupled system. For example, SSO log in credentials such as a username and/or password may be received via a user interface 102 or through an employee workstation enabled to present a user interface 102. A log in may, in embodiments, identify the user as being associated with an organization, such as a business. The user may be identified via log in credentials as having association with the individual or organization presenting a database. For example, the user may be an employee, an approved collaborator, or a guest of a business's data storage system. It will be understood that in many embodiments, users may be recognized as being associated with user accounts.

In some embodiments, a user interface 102 may inform a database controller 104. For example, log in information received via a user interface 102 may be interpreted by a database controller 104. Additionally, or alternatively, a database controller 104 may have access to information via other input systems, for example, a database controller 104 may have access to log in information via another program and/or interface associated with a desktop computer.

Aspects of the database controller 104 may exist locally on a computer system, remotely, or a combination thereof. For example, aspects may be stored in memory coupled to the display of the user interface 102 via wired and/or wireless connection. Furthermore, the database controller 104 may have access to various information stores. As described herein, information available to a database controller, such as database controller 104, will similarly be understood to encompass systems coupled via means known in the art, including direct connection, remote connection, or a combination thereof.

The database controller 104 may, in various embodiments, have access to information associated with the user and/or user account. Information associated with a user and/or user account may comprise information useful for determining a user's authorized and/or desired access to a database system. For example, such information may comprise an indication of a user's permission level, wherein a permission level may be determined according to a user's association with a provider of a database system (for example, an employee or a guest), a user's role (for example, an entry-level analyst or a senior manager), a user's division of work (for example, programming, finance, or human resources), a user's security clearance, or other information indicating permission implications for a user.

Information associated with a user may further comprise an indication of a user's skill level and/or expertise. Skill level and/or expertise may be related to a user's technical experience, for example, with relational database systems, and be based upon received training, work experience, and/or other information useful for estimating a user's proficiency with software, programs, and/or other tools relating to dataset storage, manipulation, and/or presentation. In some embodiments, nuanced perspective of a user's skill level may be known via a plurality of metrics relating to particular skills. For example, a user may be shown to have an advanced skill level in data visualization but an elementary skill level in manipulation of relational databases via SQL.

Furthermore, information associated with a user may comprise an indication of a user's required access to at least one aspect of a database. In some embodiments, required access may relate to aspects of data which a user may need access to. As users involved with various projects relating to complex data systems may require access to different components of data, various embodiments may take advantage of an indicator of which aspects and/or schemas of data should be made available to a user. For example, a database available for a healthcare provider may comprise information comprising a plurality of patient records. In this example, a collaborating researcher may need access to data pertaining to biometric statistics relating to patients with a particular ailment but not to personally identifying information, an accountant may need access to data pertaining to care decision costs and patient identity but not to specific health details, and a doctor may need access to personally identifying information in association with a patient's full health details. For each of these users and/or associated user accounts, unique indications of required access may be known to the database controller 104, for example, as associated user data.

In some embodiments, indication of a user's required access may pertain to access to features of the system. For example, advanced query features may be required by a data analyst, while more advanced data visualization features may be required by a business strategist. For each of these users, unique indications of required access may be known to the database controller 104.

In various embodiments, aspects of information associated with a user may take the form of tags, enumerated values, or other format used in the art. Embodiments may make use of a plurality of such indications such as will be recognized as being useful for ascertaining a proper customization of a user experience for a user. Such information may be received, in embodiments, via the user interface 102, be preconfigured, or be stored in memory coupled to the database controller. Embodiments are not limited in this context.

The database controller 104 may, in embodiments, have access to information comprising previous access records. Access records may comprise historical data and/or metadata related to previous data creation, access, and/or manipulation. In some embodiments, aspects of access records may be associated with a user or users. In some embodiments, aspects of access records may be associated with a time stamp or other indication of the historical setting of the record. In some embodiments, aspects of access records may include representation and/or information pertaining to an event described by the record. For example, an access record may include a snapshot, a record of tracked changes made to a dataset, a snippet and/or summary of changes made, a tag indicating what data was accessed and/or how data was manipulated, a link to a version of a dataset, a user name identified with a change made, a time stamp of the change made, and/or other information useful for determining the history of a dataset and/or a user's interaction with a dataset.

Based upon information available to the database controller 104, the database controller 104 may adjust and/or change aspects of the user interface 102 presented to the user. For example, features and/or aspects of data and/or schemas may be made available and/or unavailable to a user via the user interface 102 according to permission levels and/or required access associated with that user. In another example, a user interface 102 may be altered according to a user's skill level. For instance, a user interface 102 may be manipulated to allow for SQL querying of database records for a user skilled in relational database manipulation via complex operators. In another instance, a user interface 102 may be manipulated to present simple visualizations of datasets and/or enable known spreadsheet operations for a user with experience limited to experience with spreadsheet applications.

Embodiments may affect a user interface by taking advantage of a combination of features known via spreadsheet and database platforms. For example, a user interface 102 may be adjusted for a user having little experience in database manipulation via complex operators by providing options to perform queries of a database via a user-friendly GUI rather than via SQL. The user interface 102 may then be used to visualize query results using methods previously only available in spreadsheet applications. Embodiments are not limited in this context.

In some embodiments, a user interface 102 may be used to provide assistance and/or resources to users according to their skill level and/or access requirements. For example, a database controller 104 may recognize that required access for a user encompasses material of greater complexity than the user's skills indicate experience in. In this case, the database controller 104 may direct the presentation of an in-application tutorial to the user via the user interface 102, or the database controller 104 may direct the user interface 102 to display a link to external resources.

The database controller 104 may, in embodiments, have access to at least one database 106. A database 106 may comprise data of any expected size, plurality, and/or schema. For example, a database 106 may comprise a single row of cells of data, a plurality of tables, or a plurality of schemas. In embodiments, a database 106 may comprise a configuration management database (CMBD) system. In some embodiments, aspects of a database 106 may be managed by an individual and/or party managing, providing, and/or using the database controller. For example, if a bank is using the system described herein, a database 106 may comprise financial records of customers as managed by the bank. In some embodiments, aspects of a database 106 may be provided by a third party. For example, a database 106 may comprise a database managed and/or hosted by a cloud service, other company, or other data repository. A database 106 may be accessed directly and/or via known protocols such as lightweight directory access protocol (LDAP).

In some embodiments, a database 106 may be accessed according to user authentication. In some embodiments, data available to a database controller, as discussed above, may be used to authenticate a user and/or user account. Aspects of authentication may be automated according to a pre-configuration of information relating to a user and/or user account. Additionally, or alternatively, aspects of authentication may be performed using information actively received via the user interface 102.

According to information available to a database controller 104, the database controller 104 may selectively access a database 106. For example, a database controller 104 may access certain schemas of a database 106 relating to a role of a user, which may then be presented via the user interface 102. In some embodiments, a database controller 104 may access a database 106, retrieve information, and then selectively present the information via user interface 102 according to information known to the database controller 104. Embodiments are not limited in this context.

In some embodiments, information may be received via a user interface 102 directing the database controller 104 to access at least one additional database 106. The database controller 104 may collect and/or access authentication data as needed, verify permissions, confirm required access, and/or otherwise use information available to it to validate that the connection may be made on behalf of the user and/or user account. In some cases, no authentication may be needed, and the approval may be automatic. According to successful validation, the database controller 104 may then access the database 106.

In some instances, aspects of a database 106 may inform a database controller 104. For example, a database 106 may be used to update and/or add to access records available to a database controller 104.

One database 106 may, in some embodiment, be validated via use of another database 106. In other words, a database controller 104 may be coupled to a plurality of databases 106 containing at least some redundant data. Differences between data may be flagged as potential discrepancies. In some embodiment, potential discrepancies and/or matches may be presented via a user interface 102. A user interface 102 may receive directions to correct aspects of one or more database 106 according to the potential discrepancies and/or matches. In response, the database controller 104 may be used to enact the directed amendments to the one or more database 106. In some embodiments, at least one database 106 may be used to validate information available to a database controller 104 as pertaining to a user. For example, an external record may be accessed which contains employee records, the record to indicate that an employee has been promoted to a higher permission level.

The database controller 104 may automatically update data and/or allowed permissions for the user accordingly and/or flag the discrepancy for human review. Human review may encompass confirmation and/or denial of the appropriateness of a record change according to the discrepancy by an authorized user, wherein the authorized user may be the user presently interacting with the system, another user, and/or a user from a group of users with certain permission levels or from a known whitelist of administrators. Determination of action, for example, automatic update or flagging for human review, may be performed according to the presence or absence of factors, for example, an indication and/or tag indicating that a discrepancy is the result of an authorized administrator making a change. In another example, discrepancies in data may be automatically flagged for human review. Additionally, or alternatively, determination of action may be performed according to a plurality of factors and/or criteria. For example, determination may be made according to a probabilistic estimation of the appropriateness of a discrepancy reflected in one of many aspects of a database 106. In some embodiments, human review and confirmation/rejection of a change may be enabled via the user interface 102.

In some embodiments, the database controller 104 may be used to update at least one record of information available to it, for example, as relating to a user's permission level, skills, or required access. In some embodiments, a database controller 104 may receive a request for an amendment of access protocols and/or rules. For example, a database controller 104 may receive a request for an update to required access records so as to indicate a user's need for further access levels. In some embodiments, a request may be received via the user interface 102 in association with the user making the request. Accordingly, the database controller 104 may automatically enact the change and/or flag the change for human review. Human review may encompass confirmation and/or denial of the appropriateness of a record change according to the request and/or approval by an authorized user, wherein the authorized user may be the user presently interacting with the system, another user, and/or a user from a group of users with certain permission levels or from a known whitelist of administrators. Determination of action, for example, automatic update or flagging for human review, may be performed according to the presence or absence of factors, for example, an indication and/or tag indicating that a change is the result of an authorized administrator making a change. In another example, changes in records may be automatically enacted but flagged for subsequent human review. Additionally, or alternatively, determination of action may be performed according to a plurality of factors and/or criteria. For example, determination may be made according to a probabilistic estimation of the appropriateness of a change according to a number of pieces of information about a user. In some embodiments, human review and confirmation/rejection of a change may be enabled via the user interface 102.

In many embodiments, a database controller may be accessed by a plurality of users. Access may occur in series or in parallel. Regardless of timing of accesses by different users, a user interface 102 may be provided to each user according to information available to the database controller 104 associated with that user, as described herein. A database controller may, in many embodiments, provide the same or differing aspects of a database 106 to different users via different respective user interfaces 102. In some embodiments, a database controller 104 may comprise a plurality of processors and/or servers collaborating as a single controller or a plurality of controllers. Functionality may be distributed. Embodiments are not limited in this context.

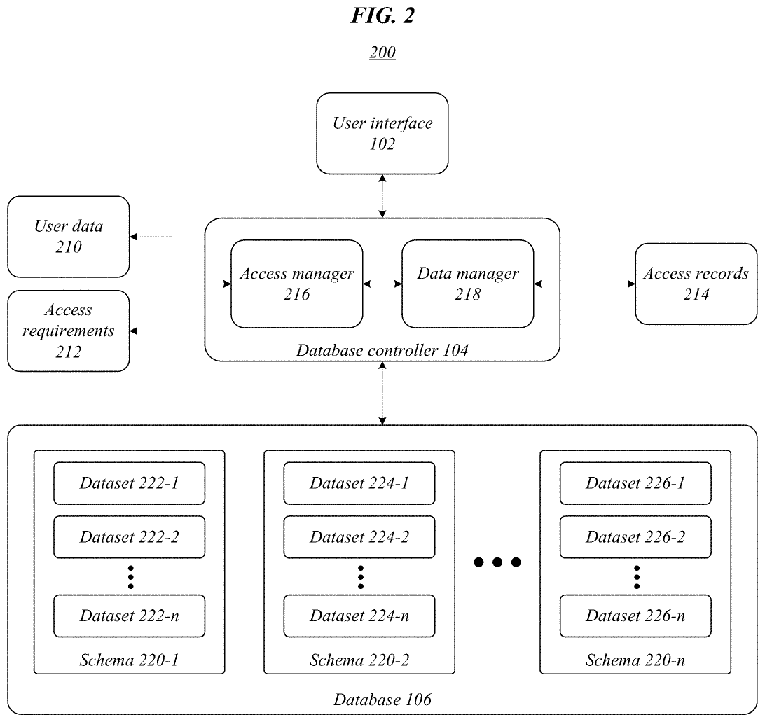

FIG. 2 is a detailed block diagram illustrating exemplary components that may be used according to one or more embodiments described herein. In system 200, a user interface 102 may be used to interact with a database controller 104, which may have access to data including user data 210, access requirements 212, and/or access records 214. The database controller 104 may be used to access and/or manipulate aspects of a database 106, which, in some embodiments, may contain a plurality of schemas. Embodiments are not limited in this context.

A user interface 102 may receive input, for example, from a user. The user interface 102 may be a GUI displayed on a computer or another form of interface known in the art. In many embodiments, the user interface 102 may be implemented as described with respect to FIG. 1. The user interface 102 may be coupled to a database controller 104, and the user interface 102 may be used to receive input to and/or access data according to the database controller 104. For example, a user interface 102 may be used to enter user credentials and/or login information associated with access to a database controller 104.

In many embodiments, a user interface 102 may receive input corresponding to requested access, storage, and/or manipulation of at least one database 106. For example, a user interface 102 may receive an access request. Access, storage, and/or manipulation of the at least one database 106 may be regulated by the database controller 104. This may be done, in various embodiments, in accordance with information received via the user interface 102. For example, a user interface 102 may receive instructions to access a database 106, and aspects of the database 106 may be made available via the user interface 102 according to login information received via the user interface 102 and processed by the database controller 104.

In various embodiments, the database controller 104 may have access to information such as user data 210, access requirements 212, and/or access records 214. Aspects of such data may be received via a user interface 102. Alternatively, and/or additionally, aspects of such data may be preconfigured or accessed from at least one datastore and/or memory. For example, aspects of user data 210, access requirements 212, and/or access records 214 may exist in at least one database. It will be recognized that user data 210, access requirements 212, and/or access records 214 may exist locally and/or remotely. Furthermore, it will be recognized that access of such data may be over a remote and/or direct connection. Embodiments are not limited in this context.

User data 210 may comprise information useful for determining a user's identity, permission level, security clearance, past and/or current projects, experience level, skills, location, team, collaborators, and/or other information relevant to a user's role. Information may be stored in indications including numerical values, including enumerated variables, percentages, tags, strings, or other value. Such information may be stored in a table, database, or other form of data store known in the field.

In some cases, user data 210 may comprise a database including data for a plurality of users. Users may have varying information fields saved according to a pre-configuration and/or what information has been made available to the system 200 via a user interface 102. In some embodiments, user data 210 may be added, deleted, and/or edited for one or more users via a user interface 102. A user's ability to manipulate the user data 210 via the user interface 102 may be determined according to a permission setting, for example, based on information stored in the user data 210.

Various embodiments may include access requirements 212. Access requirements 212 may comprise information useful for determining which, if any, aspects of data and/or functionality should be made available to one or more user. This may comprise relationships between aspects of data, for example, as well as relationships between types of data and user roles, user projects, or other level of user involvement. Further examples include associated permission levels, privacy levels, security restrictions, and other fields that may be associated with at least one user and/or user role. Additionally, and/or alternatively, access requirements 212 may pertain to a user and/or user role's ability and/or needs to access functionality of the system, for example, as enabled by a database controller 104. Information may be stored in indications including numerical values, including enumerated variables, percentages, tags, strings, or other value. Such information may be stored in a table, database, or other form of data store known in the field. Similar to user data 210, access requirements 212 may be updated and/or manipulated via a user interface 102.

In some embodiments, a database controller 104 may have access to and/or take advantage of access records 214. Access records 214 may include indications of at least one user's historical, present, and/or estimated access of one or more aspects of the system 200. For example, at least one indication of input received via a user interface 102 in association with a user account may be stored in access records 214, or at least one indication of the presentation of at least one aspect of a database 106 via a user interface 102 may be stored in access records 214. Access records 214 may comprise an indication of an activity, a user associated with the activity, and/or a timestamp of the activity. Information may be stored in indications including numerical values, including enumerated variables, percentages, tags, strings, or other value. Such information may be stored in a table, database, or other form of data store known in the field. Similar to user data 210, access records 214 may be presented, updated and/or manipulated via a user interface 102.

Access records 214 may, in various embodiments, be used to inform access requirements 212. Access requirements 212 may be updated via a user interface 102. Additionally, and/or alternatively, access requirements 212 may be updated automatically. For example, a database controller 104 may retrieve access records 214 and update access requirements 212 according to access trends, updates, and/or estimates determined via pre-configured rules, a machine learning component, and/or other processing method known in the field.

In many embodiments, a database controller 104 may affect the presentation of aspects of a database 106 via a user interface 102 based on information available to it, for example, user data 210, access requirements 212, and/or access records 214. In many embodiments, a database controller 104 may use an access manager 216 and/or a data manager 218 to process and/or inform data such as user data 210, access requirements 212, and/or access records 214. In embodiments, an access manager 216 and a data manager 218 may inform each other.

An access manager 216 may have access to data such as user data 210 and/or access requirements 212. In various embodiments, aspects of user data 210 and/or access requirements 212 may be associated with a user and accessed by the access manager 216 according to information received via a user interface 102. For example, a user login may be received via a user interface 102 and used to access user data and access requirements indexed by user.

In various embodiments, an access manager 216 may determine aspects of a user experience according to user data and/or access requirements 212. User interface functionality, for example, may be adjusted according to user data and/or access requirements known to the access manager 216. For example, user data 210 indicating that a user has a low skill level and access requirements 212 indicating a low access level may be provided to the access manager 216. In this example, the access manager 216 may present a version of the user interface 102 with streamlined functionality. Complex query features may be made less prevalent, minimized, or not shown, for example, while simplified options may be represented in the user interface 102 via graphical objects. In some embodiments, prompts such as tips may be provided to the user via the user interface 102 according to a determination by an access manager 216 that the user is of a low skill level.

In some embodiments, an access manager 216 may regulate presentation of particular aspects of a database 106. For example, an access manager 216 may determine using user data 210 that a user has a permission level that does not allow for access of a schema in a database 106. In this case, the access manager 216 may be used to regulate presentation of the database 106 via the user interface 102 so to exclude that schema. In many embodiments, this may be done in conjunction with a data manager 218. In some embodiments, an access manager may manipulate security, permission, and/or access settings associated with at least one aspect of a database 106.

A data manager 218 may be used to regulate aspects of availability of at least one database 106. Regulation of availability may be based on data or instructions from the access manager and/or other aspects of the database controller 104. Furthermore, activity concerning the data manager 218 may be recorded and/or memorialized in access records 214.

In various embodiments, a data manager 218 may store, update, and/or access aspects of a database 106. For example, based upon input received via a user interface 102 and an indication of an associated user's approval received from an access manager 216, a data manager 218 may retrieve one or more pieces of data from at least one database 106. Based upon information available to the data manager, for example, via a user interface 102, the data manager may manipulate aspects of a database 106. For example, the data manager 218 may delete a row in a dataset, join two schemas, and/or change settings associated with a database. Embodiments are not limited in this context.

Each database 106 of system 200 may comprise multiple components. For example, a database 106 may comprise a plurality of schemas, such as schema 220-1, schema 220-2, . . . schema 220-n, where n is a positive integer. Schemas in a database may conform to the same or to different organizational structures, and relationships may exist between data within and/or between schemas. Each schema in a database 106 may comprise one or more datasets. For example, schema 220-1 may comprise dataset 222-1, dataset 222-2, . . . dataset 222-n, where n is a positive integer. As another example, schema 220-2 may comprise dataset 224-1, dataset 224-2, dataset 224-n, where n is a positive integer. As yet another example, schema 220-n may comprise dataset 226-1, dataset 226-2, . . . dataset 226-n, where n is a positive integer. Datasets may contain data comprising the same or different sizes, formats, data types, relationships, and/or a combination thereof. For example, datasets may contain mutable and/or immutable data, joined columns and/or rows, indexed tables, etc. Embodiments are not limited in this context.

In many embodiments, aspects of a database 106 may be associated with a permission level and/or complexity level. A schema, dataset, and/or field in a dataset may be associated with the same or different permission levels and/or complexity levels as other data in the database 106. For example, a column in a table may accessible only to users associated with a specific security level and higher, and the table may comprise data with highly complicated relationships between data components and be associated with a high complexity level. Permission levels and/or complexity levels associated with aspects of a database 106 may be utilized by a database controller 104 to affect the presentation of data and/or functionality via a user interface 102. In many embodiments, user data 210 and access requirements 212 may be used in conjunction with permission levels and/or complexity levels associated with a database 106 by a database controller 104. For example, the database controller 104 may determine that a user is associated with a low permission level and present via the user interface 102 only aspects of a dataset 222-1 which have a similarly low permission level associated.

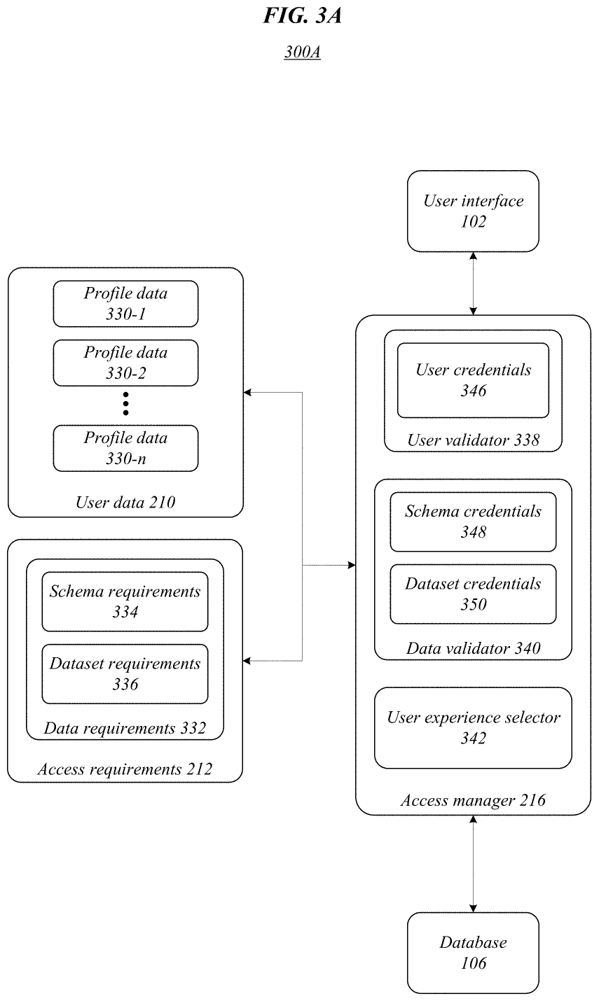

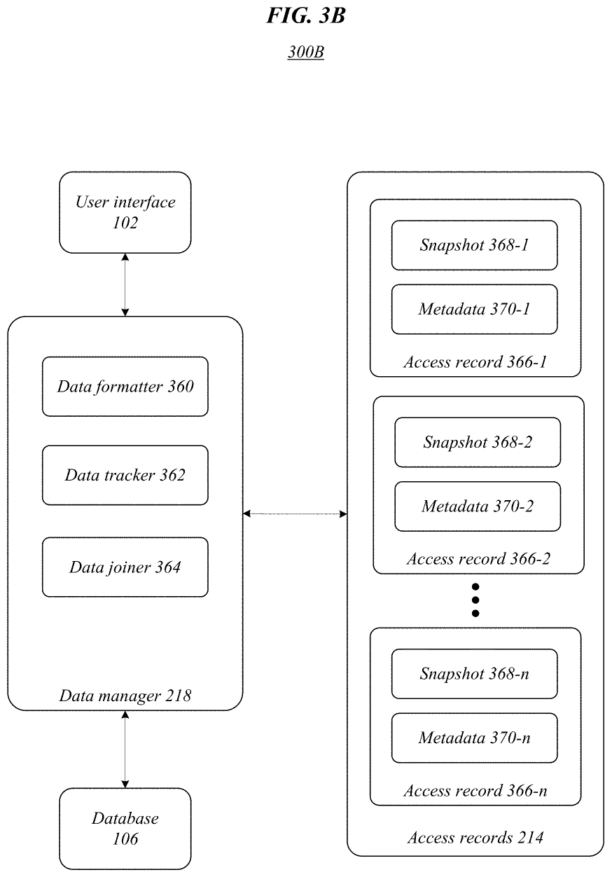

FIGS. 3A and 3B are a detailed block diagrams illustrating exemplary components that may be used according to one or more embodiments described herein. In FIG. 3A, system 300A illustrates components that may be used in association with an access manager, such as the access manager 214 discussed with respect to FIG. 2. In FIG. 3B, system 300B illustrates components that may be used in association with a data manager, such as the data manager 218 discussed with respect to FIG. 2. Embodiments are not limited in this context.

As shown in FIG. 3A, user data 210 and access requirements 212 may be available to an access manager 214.

User data 210 may comprise a plurality of sets of profile data. For example, user data 210 may comprise profile data 330-1, profile data 330-2, . . . profile data 330-n, where n is a positive integer. Each set of profile data may be associated with a different user and/or a plurality of users. Profile data may comprise at least one identifier of a user, such as a user name, employee number, email, or other identifier. Additionally, profile data may comprise data such as a password, information about employment, permission levels, security levels, skill levels, experience levels, data for verifying the identity of a user, and/or other information concerning the user.

Access requirements 212 may comprise information useful for determining which, if any, aspects of data and/or functionality should be made available to one or more user. This may comprise relationships between aspects of data, for example, as well as relationships between types of data and user roles, user projects, or other level of user involvement. Further examples include associated permission levels, privacy levels, security restrictions, and other fields that may be associated with at least one user and/or user role.

Aspects of access requirements 212 may comprise data requirements 332. Data requirements may comprise information concerning at least one user and/or user role in association with one or more components of data. For example, data requirements 332 may comprise at least one indication that a database 106 may be accessible by a set of user roles. In some embodiments, access requirements 212 may also include schema requirements 334 and/or dataset requirements 336. Schema requirements 334 and/or dataset requirements 336 may relate to data permissions, security, complexity, and/or project relevance for a particular schema and/or dataset. For example, schema requirements 334 and/or dataset requirements 336 may comprise permission and/or complexity levels as described with respect to FIG. 2.

In some embodiments, indications of requirements for databases, schemas, and/or datasets may differ. In some embodiments, the higher level data structure's requirement indication may supersede the lower level data structure's requirement indication. For example, access requirements 212 may indicate that one dataset may have a low access requirement but the database within which the dataset exists has a high access requirement. In this example, the database-associated requirement indication may be used by the access manager 216 rather than the dataset-associated requirement indication. Benefits of such behavior may include maximizing data privacy. In some embodiments, however, requirement indications associated with lower level data structures may supersede those associated with higher level data structures. For example, a low requirement level associated with a dataset may have priority over a high requirement level associated with the database containing the dataset, thereby preferencing access to data. In some embodiments, these exceptions and/or preferences of priority of requirement indications may be set for individual data structures and/or groups of data structures. For example, a default may be set but later altered for a particular data set. Additionally, and/or alternatively, a default may be set but later altered for a particular user and/or user role. Customization of access rules may enable a system to be used effectively by users while maintaining a high degree of data privacy.

Aspects of user data 210 and/or access requirements 212 may inform/be informed by an access manager 216. For example, user data 210 and/or access requirements 212 may be used in association with an access manager 216 in ways such as those described with respect to FIG. 2.

An access manager 216 may include components such as a user validator 338, a data validator 340, and/or a user experience selector 342.

A user validator 338 may be used to verify that a user of the system, such as system 100, may be approved and/or permitted to use the system. This may be done, for example, via identity verification. In many embodiments, identity may be verified based on one or more received inputs. For example, a user validator 338 may match a user name, password, and/or answer to a security question received via a user interface 102 to user credentials 346 known to the access manager 216 via a connection to memory and/or pre-configuration. In some embodiments, a user validator 338 may verify a user's identity based upon multifactor authentication. A user validator 338 may be configured to receive input from a separate device, such as a phone, as an example. In some embodiments, a user validator 338 may be coupled to devices configured to receive biometric data useful for verifying the identity of the user. For example, the user validator 338 may be coupled to a fingerprint reader, camera, voice recorder, iris scanner, or other device known in the art. Aspects of the user validator 338 may confirm the identity of a user according to a probabilistic determination of a match of biometric data in some embodiments. For example, a user validator 338 may use machine learning to probabilistically determine a match of identity or lack thereof. In some embodiments, aspects of user credentials 346 may be retrieved from or confirmed using profile data included in user data 210.

A data validator 340 may be used to determine that one or more aspects of a database 106 may be accessed by a user associated with a user account and/or user role. A data validator 340 may determine the validity of an access request according to schema credentials 348 and/or dataset credentials 350. In some embodiments, an access request received via a user interface 102 may comprise schema credentials 348 and/or dataset credentials 350. Schema credentials 348 and/or dataset credentials 350 may comprise information indicating location and/or relationships of at least one schema and/or dataset with respect to other data components of a database 106. For example, schema credentials 348 for a schema may indicate the schema as being a schema associated with a particular database, and dataset credentials 350 for a dataset may indicate the dataset as being a dataset associated with a particular schema, database, and/or schema in a database.

In some embodiments, a data validator 340 may retrieve aspects of user data 210 based on validation of a user by the user validator 338, then validate aspects of a database 106 for presentation via a user interface 102 based on user data 210, access requirements 212, schema credentials 348, dataset credentials 350, and/or a combination thereof.

In some embodiments, user experience selector 342 may be used to customize aspects of database 106 presentation, data visualization functionality, and/or data manipulation functionality via a user interface 102. A user experience selector 342 may determine a customization according to aspects of user data 210, including user skills and/or user preferences. Additionally, and/or alternatively, a user experience selector 342 may determine a customization according to aspects of access requirements 212 and/or validation of data use by a data validator 340. For example, only aspects of a database 106 that are indicated in schema requirements 334 and/or dataset requirements 336 may be presented via a user interface 102. In an example, the user experience selector 342 may be used to present simplified and/or limited functionality via the user interface 102 to users with low need and/or skill levels, thereby curating a less confusing user experience than would otherwise be provided with communication of full system complexity. In another example, the user experience selector 342 may be used to present highly complex data and/or functionality via the user interface 102 to users with high need and/or skill levels, thereby enabling complex database system performance.

In some embodiments, a user experience selector 342 may provide via a user interface 102 administrative privileges to users. In some embodiments, this may be done based on user data 210 and/or access requirements 212. Administrative privileges may comprise ability to edit aspects of at least one database 106, user data 210, access requirements 212, user credentials 346, schema credentials 348, dataset credentials 350, settings such as which databases 106 are used, preferences for capture of access records 214, as well as viewing and/or manipulation of other functionality as described herein.

As shown in FIG. 3B, a data manager 218 may be used to access, create, and/or manipulate aspects of one or more database 106. These procedures may, in many embodiments, be performed based on input received via a user interface 102.

A data manager 218 may comprise components such as a data formatter 360, a data tracker 362, and a data joiner 364. It will be recognized that a data manager 218 may comprise further components useful for accessing, creating, and/or manipulating aspects of at least one database 106.

A data formatter 360 may be configured to retrieve data from one or more database 106 with one or more native formats and manipulate the data format for uniform and/or appropriate presentation via a user interface 102. In many embodiments, the data formatter 360 may adjust the format of data from at least one database 106 according to a determined user experience as explained with respect to FIG. 3A. In some embodiments, a data formatter 360 may adjust the formatting of at least one dataset, schema, and/or database in order to allow joining operations, for example, as enacted by a data joiner 364. In some embodiments, a data formatter 360 may intermittently synchronize aspects of at least one dataset, schema, and/or database in order to generate similar formatting between the two. For example, a portion of a first table may be intermittently synchronized with a portion of a second table in order to allow a data joiner 364 to join the two table portions.

A data tracker 362 may be used to track access, addition, deletion, and/or manipulation of data in at least one database 106 by a data manager 218. For example, a data tracker 362 may maintain a record of queries received via a user interface 102 and changes made to data in at least one database 106. In some embodiments, a database 106 may be maintained or accessed via platforms that do not use the data manager 218. For example, a database may be maintained by a third party. A data tracker 362 may additionally and/or alternatively recognize changes to aspects of a database 106 that were not enacted by the data manager 218. A record may still be maintained in these embodiments, and in some cases, metadata indicating details of the activity and/or acting party may be associated with the tracked data change.

A data joiner 364 may be used by the data manager 218 to interact with one or more aspects of at least one database 106. Specifically, a data joiner 364 may be used to retrieve specific aspects of at least one database 106 according to one or more queries and/or commands. Join queries and/or commands may include data joining functionalities such as inner joins, in which data is returned when all conditions of a query are met, left joins, in which data is returned for all fields of a first dataset and all fields in a second dataset meeting conditions of a query, right joins, in which fields of a first data set meeting conditions of a query and all fields of a second data are returned, and full joins, in which all fields from a first and second dataset are returned. Embodiments are not limited in this context, and it will be recognized that additional functionality known in the field may be enabled by the data joiner 364. For example, a data joiner 364 may be used to retrieve select information from at least one database 106 according to queries and/or commands and then perform mathematical calculations, relational operations, and/or a combination thereof on the returned data. Additionally, and/or alternatively, the data joiner 364 may be used to create new sets of data, for example, a result of a series of queries, and the data manager 218 may be used to save the new set as an aspect of at least one database 106.

Additionally, and/or alternatively, a data joiner 364 may be used to define new relationships and/or rules surrounding aspects of at least one database 106. For example, a data joiner may be used to link multiple pieces of data in at least one database 106 according to queries and/or commands received via a user interface 102.

In some embodiments, a data formatter 360 and a data joiner 364 may work in tandem and/or inform each other. For example, a data joiner 364 may be used to collect data meeting a certain set of criteria and a data formatter 360 may be used to present and/or visualize the data together. Activity involving either of these components of the data manager 218 may be further memorialized by the data tracker 362.

A data manager 218 may have access to access records 214. Access records 214 may comprise a plurality of records of historical and/or current access of one or more aspects of a database 106 by a data manager 218. For example, access records 214 may comprise access record 366-1, access record 366-2, . . . access record 366-n, where n is a positive integer. Each access record in access records 214 may comprise data and/or information useful for determining the nature and/or context of an access to a database 106. In many embodiments, an access record may comprise a snapshot and/or metadata relating to the access of data. For example, access record 366-1 may comprise snapshot 368-1 and metadata 370-1, access record 366-2 may comprise snapshot 368-2 and metadata 370-2, . . . and access record 366-n may comprise snapshot 368-n and metadata 370-n, where each n may represent the same or a different positive integer. Embodiments are not limited in this context.

Each snapshot in access records 214 may include data useful for determining the nature of an access of data. In some embodiments, this may be a screenshot or capture of an access event, such as a record of changes made to a database 106. In some embodiments, this may comprise text data and/or code describing actions taken by a data manager 218, a database controller, via a user interface, and/or a combination thereof. For example, a record of at least one query received via a user interface 102 may be maintained as a snapshot. Various embodiments may include screenshots comprising data captured by a data tracker 362. In embodiments where access records 214 contain a plurality of snapshots, the snapshots may take a plurality of forms or conform to a uniform format.

Metadata included in access records 214 may comprise data useful for providing the context of an access of data. For example, metadata such as metadata 370-1 may comprise a time stamp, an indicator of an associated user, a tag indicating a project, and/or an indicator of a specific version of a dataset. Embodiments are not limited in this context.

In some embodiments, snapshots and/or metadata may be collected as aspects of access records 214 automatically. In some embodiments, recording of a snapshot and/or metadata may be triggered by an event, for example, an elapsed period time or the receiving of an access request via a user interface 102 to manipulate a database 106. Additionally, and/or alternatively, aspects of access records 214 may be recorded manually and/or according to input received by the data manager 218, for example, via the user interface. For example, the user interface 102 may receive a request to capture access record 366-1 and then later a request to capture access record 366-2 as an act to record versions 1 and 2 of a database 106 being manipulated.

Aspects of access records 214 may be saved and made available via a user interface 102. In some embodiments, this may be limited to particular user experiences as described with respect to FIG. 3A. It will be readily understood that maintenance of access records 214 may have additional benefits, such as allowing for tracking of how aspects of a database 106 has been manipulated by a plurality of users over a period of time. As a result, the integrity of data in a database 106 may be made transparent. In some embodiments, attempted manipulation of a dataset, schema, database 106 or other aspect of a system 100 may be flagged in access records. For example, attempted access and/or manipulation of a database 106 by a user with a low permission and/or level may be flagged. Flagging may be used to present aspects of the corresponding access record 366-n for further processing and/or human review.

In some embodiments, an access record 366-n may be used to revert at least one database 106 to a previous state. For example, a database 106 may be associated with access record 366-1, access record 366-2, and 366-n, each captured at a subsequent time. The access record 366-2, in this example, may be used to replace the subsequently manipulated database with the second version of the database 106. Aspects of access records 214 may be associated with at least one database 106, schema, and/or dataset.

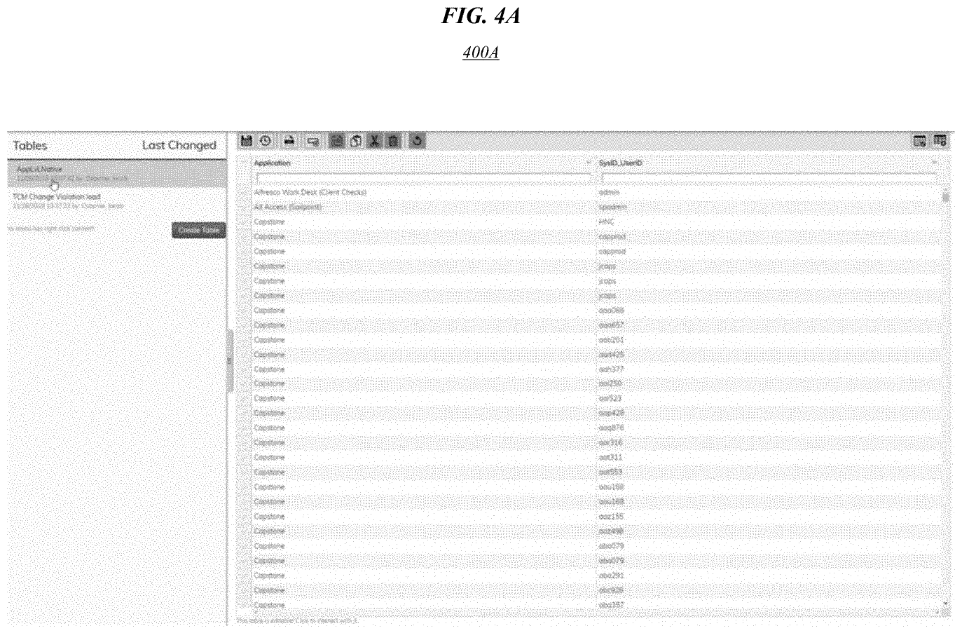

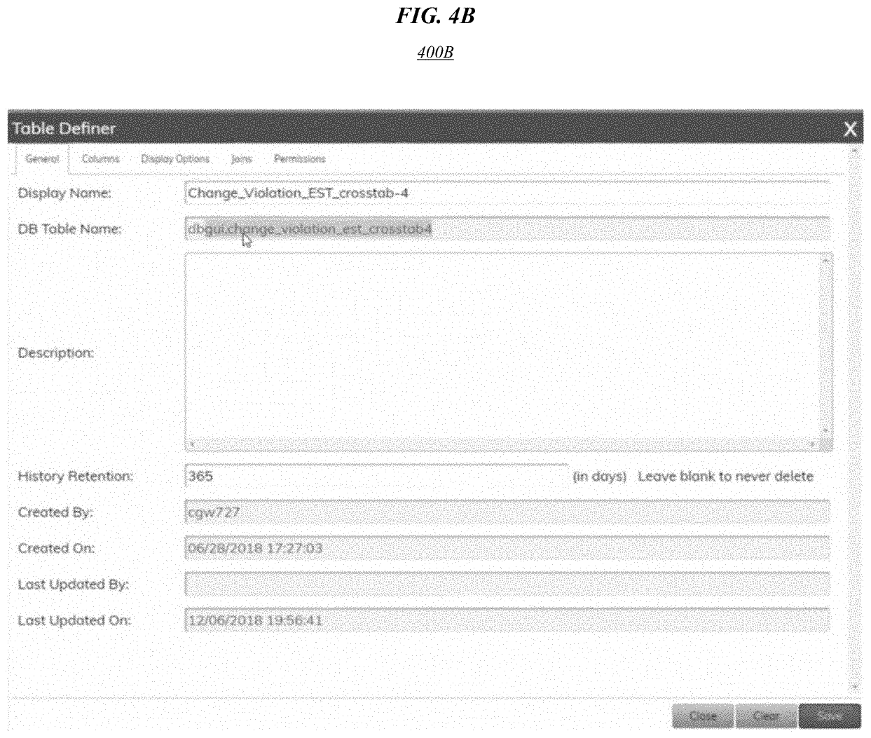

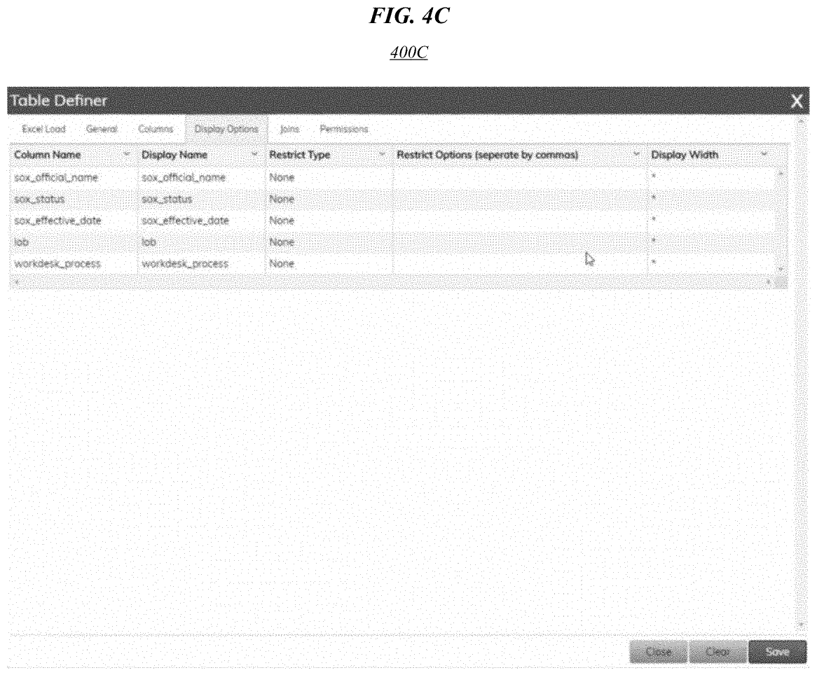

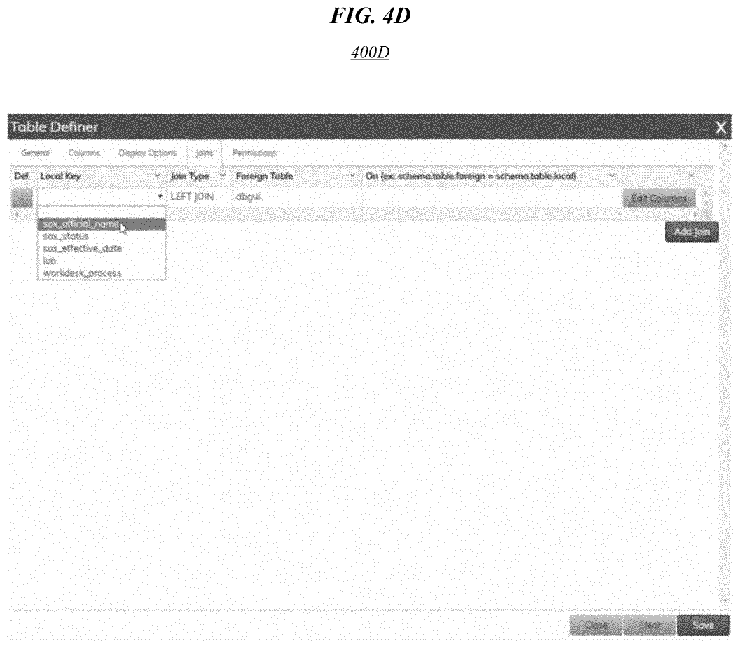

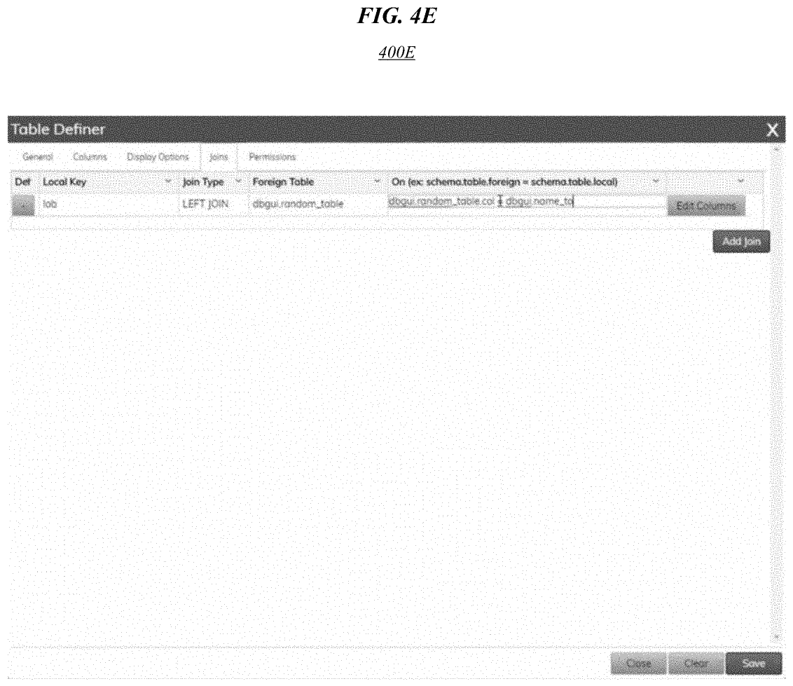

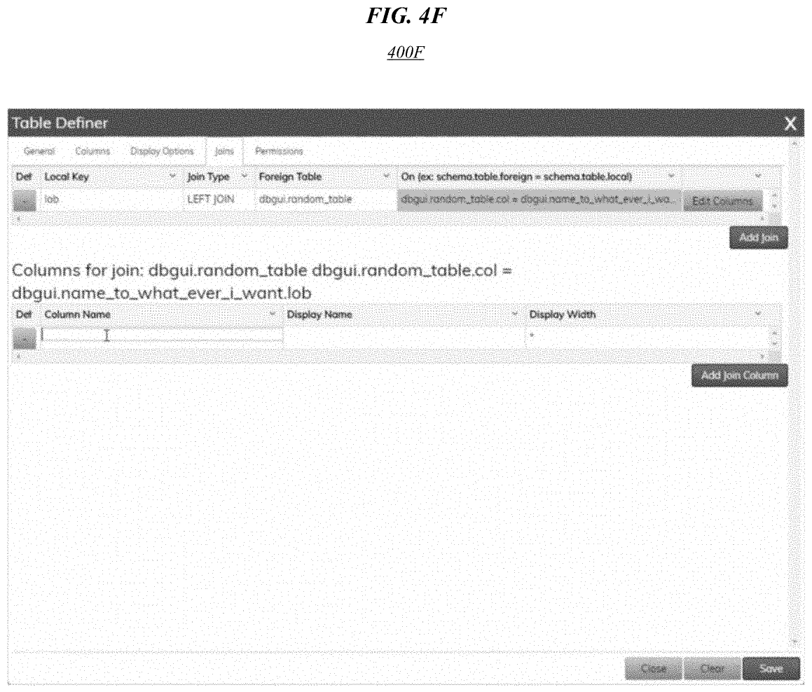

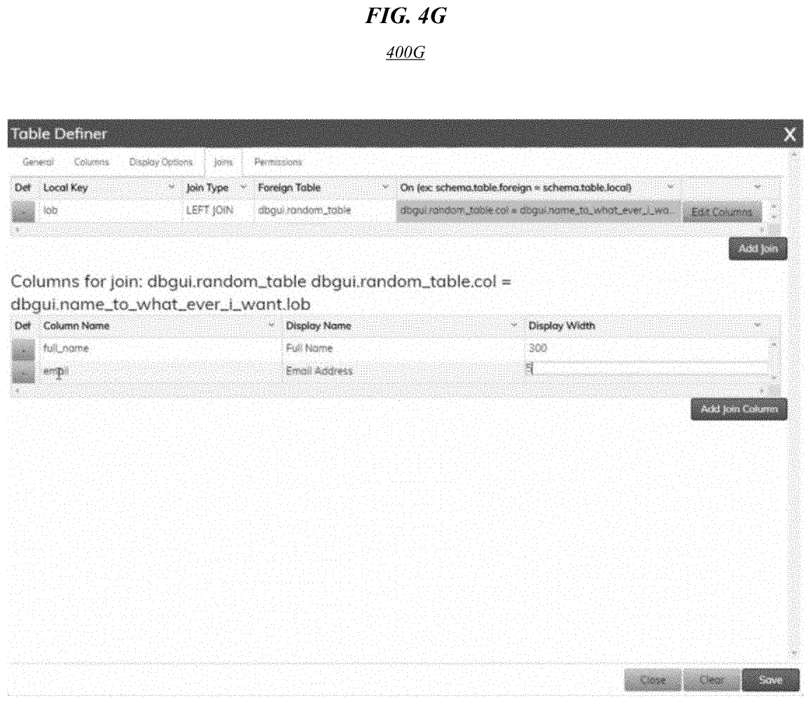

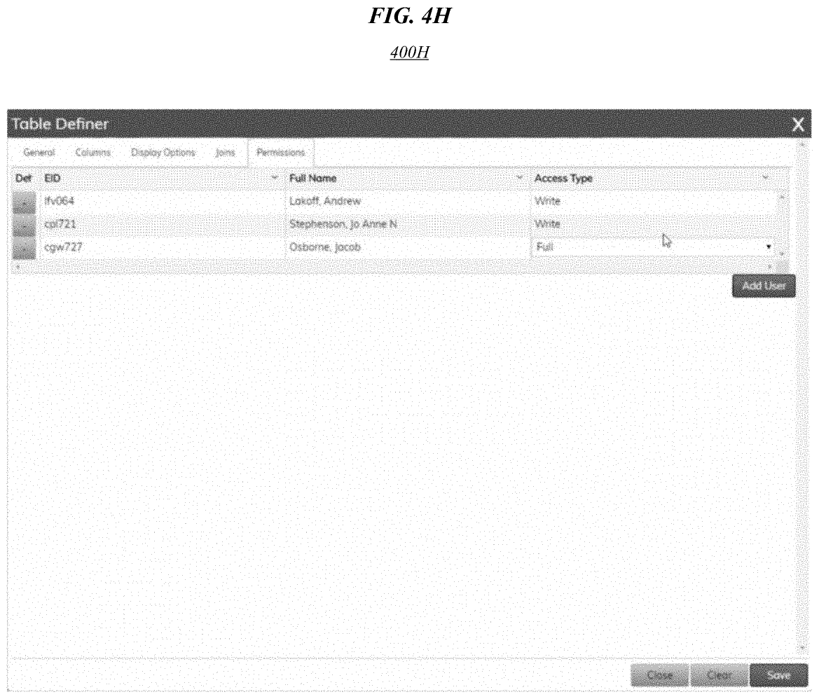

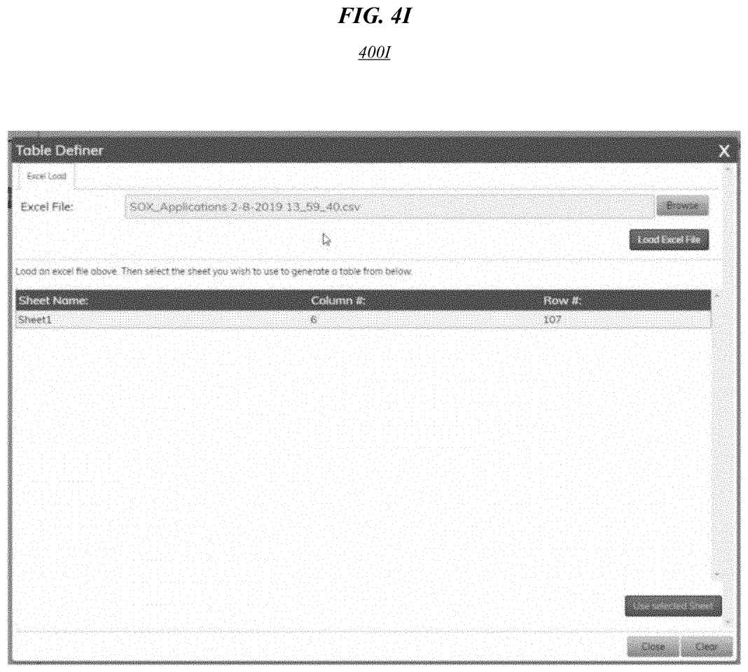

FIGS. 4A-4I illustrate exemplary aspects of a graphical user interface that may be used according to one or more embodiments described herein. It will be recognized that the functionality of the illustrated graphical user interface may be implemented using the same and/or different graphical arrangements. Embodiments are not limited in this context.

In FIG. 4A, image 400A is an example GUI such as may be provided as part of a user interface 102 described above. As shown in the left panel of the image, a plurality of tables may be made available, such as the table titled “AppLvLNative.” Tables may, in embodiments, be presented with information pertaining to a time and/or date of last manipulation. In some embodiments, the change may be associated with a user and/or user profile. For example, the table “AppLvLNative” of image 400A was last updated by a user profile associated with “Osborne, Jacob” at 19:07:42 on 11/09/2018. In embodiments, this information may be determined by a data tracker 362.

Below the listing of tables, a hint is given to the user: “This menu has right click content!” Such hints may be provided to a user as a result of a user experience determined by a user experience selector 342.

Furthermore, options to create a table may be presented via a user interface as in the “Create Table” option. Additionally, further functionality may be presented to a user, such as the ability to save at least one change, revert to a previous version of a dataset, undo at least one change, export at least one dataset, add at least one field to a dataset, as well as duplicate, copy, cut, and/or delete aspects of at least one dataset. Embodiments are not limited in this context.

Additionally, various applications and/or projects may be presented. In some embodiments, identifications of users may be associated with these aspects.

In FIG. 4B, image 400B illustrates aspects of a graphical user interface that may be associated with general functionality of the definition of a table, such as in a database 106. As shown in the illustration, details of aspects of a database, such as a table, may be manipulated for display via the user interface. For example, a simplified display name may be defined to be displayed in the user interface instead of a more complicated title associated with the table in a database 106. Additionally, a description may be provided which may provide detailed explanation of the dataset. Settings such as a history retention may be specified to maximize data records while minimizing used storage. For example, a history retention period may be specified to be 365 for a particular table to ensure that recent records are maintained in access records but cleared after 365 days.

Some fields may not be available for edit via at least one user account. For example, in image 400B, the acting user account may not have permission to edit fields such as the database table name, the identity of the table creator, the creation date of the table, the identity of the user account last used to update the table, and the timestamp of the last update. In some embodiments, restricted access to such fields according to permissions may be communicated by graying out the fields in the user interface.

In FIG. 4C, image 400C illustrates further aspects of a table definer as enabled by one or more embodiments described herein. Aspects of a dataset may be manipulated and/or arranged via a user interface. For example, columns in a table may be sorted and edited so that the same or different column names are displayed in the user interface. Access to aspects of datasets, for example, columns of tables, may be restricted and/or limited to specific users and/or user roles.

In FIG. 4D, image 400D illustrates further aspects of a table definer as enabled by one or more embodiments described herein. In some embodiments, relationships between may be defined based on input received via a user interface. In various embodiments, a data joiner 364 may be used to define relationships between aspects of data. According to various selected user experiences, aspects of data, join options, input and output options may be made available for a join via dropdown menus. Such arrangements of user interfaces may enable users otherwise unskilled in complex query languages to achieve similar functionality. As shown in FIG. 4E, image 400E illustrates an example in which the options discussed with respect to image 400D have been selected.

As shown in FIG. 4F, image 400F illustrates an arrangement such as found in at least one embodiment, in which specific formatting preferences may be set for retrieved data to be added to a table. For example, formatting may be performed via a data formatter 360. For example, a name for the new column may be set, a display name provided, and width of the column to be displayed set.

In FIG. 4G, image 400G illustrates provision of further options for formatting preferences. Aspects of a database may be assigned varying formatting preferences, such as the differing display widths set for the columns “full_name” and “email.” Embodiments are not limited in this context.

In FIG. 4H, image 400H shows aspects of a table definer relating to permissions according to one or more embodiments described herein. Employee identifiers are shown in association with employee names and the access type allowed for that employee with respect to the table being defined. Types of access may include read, write, full, or restricted, for example. In some embodiments, users may be added to a record associated with a table. Access type for a table may be assigned on a user-by-user basis.

In FIG. 4I, image 400I illustrates aspects of loading data to a table definer according to one or more embodiments described herein. In some embodiments, at least one existing dataset, schema, and/or database may be loaded into the system as a new aspect of at least one database 106, for example, via a table definer as illustrated. In some embodiments, data to be loaded via a table definer may exist in a number of formats and/or exist on a third-party platform. For example, data files may be uploaded in formats including .csv, .txt, .db, .sql, .dbf, .4db, .tsv, and/or any other known data file type. In some embodiments, aspects of an external dataset, schema, and/or database may be specified for loading/import. For example, a row and/or column may be specified in a sheet for import. In some embodiments, a data joiner 364 may be used to join imported data to at least one aspect of an existing database 106. In some embodiments, a data formatter 360 may be used to adjust the format of loaded/imported data. Embodiments are not limited in this context.

FIGS. 5A-1 and 5A-2 illustrate a first logic flow provided to describe exemplary steps that may be performed according to one or more embodiments described herein. Flow 500A includes steps useful for identifying a login of a registered user, determining a user experience based on the login, and determining whether the user is authorized to access an aspect of a database. Further steps may be useful for providing a registered user access to a dataset based upon verification of their authorization to access the dataset. Embodiments are not limited in this context.

In block 502, the login of a registered user is identified based on receipt of credentials correlated with the registered user. In some embodiments, the credentials may be matched with data from user credentials 346.

In block 504, profile data is retrieved for the registered user based on the credentials correlated with the registered user, the profile data comprising a database ability level, one or more permission levels, and one or more authorizations. In some embodiments, profile data may be retrieved from user data 210.

In block 506, a user experience is selected for the registered user based on the database ability level in the profile data retrieved for the registered user. For example, a user experience may be selected by a user experience selector 342.

In block 508, a graphical user interface (GUI) may be formatted for the registered user based on the user experience selected for the registered user.

In block 510, an access request is identified for a dataset located in a schema of a database, the database is divided into a plurality of schemas, and the access request comprising schema credentials and dataset credentials, wherein the schema credentials indicate the schema of the database and the dataset credentials indicate the dataset in the schema of the database.

In block 512, one or more schema requirements may be retrieved based on the schema credentials and one or more dataset requirements based on the dataset credentials.

In block 514, the registered user may be verified as being authorized to access the schema of the database based on the schema requirements and the one or more authorizations in the profile data.

Block 516 represents a continuation of the logic flow 500A from FIG. 5A-1 to FIG. 5A-2.

In block 518, the registered user may be verified as being authorized to access the dataset in the schema of the database based on the dataset requirements and the one or more authorizations in the profile data.

In block 520, a permission level may be determined for the registered user to access the dataset based on the one or more permission levels in the profile data, the permission level for the registered user to access the dataset comprising one or more of read access and write access.

In block 522, the registered user may be provided with access to the dataset via the GUI according to the permission level for the registered user to access the dataset.

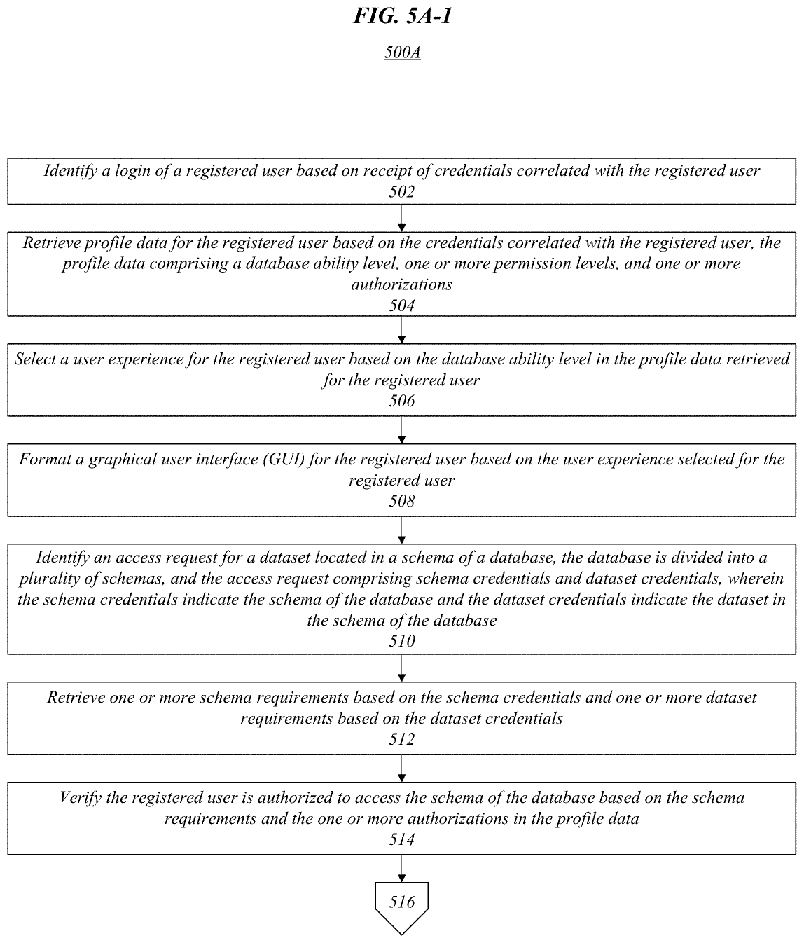

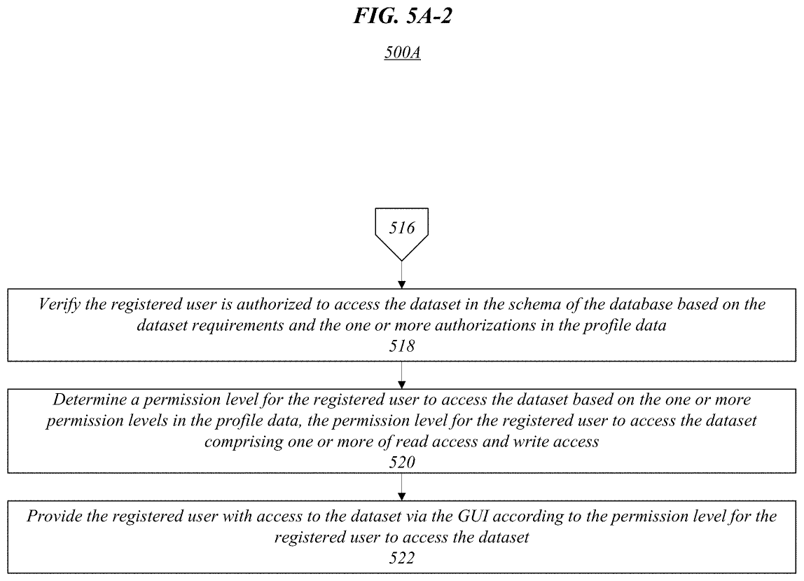

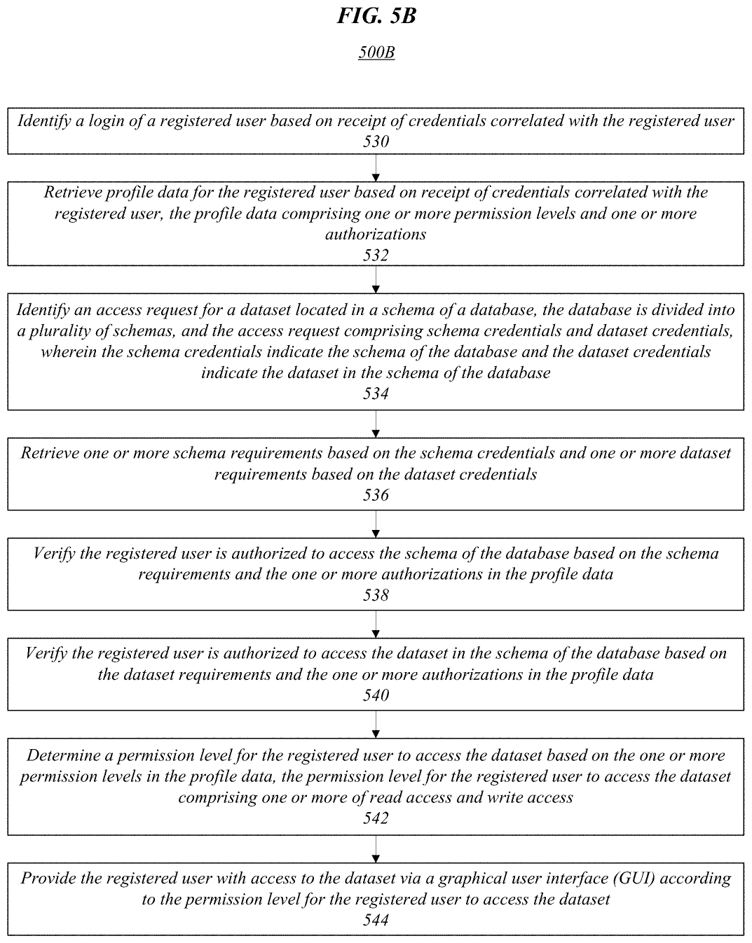

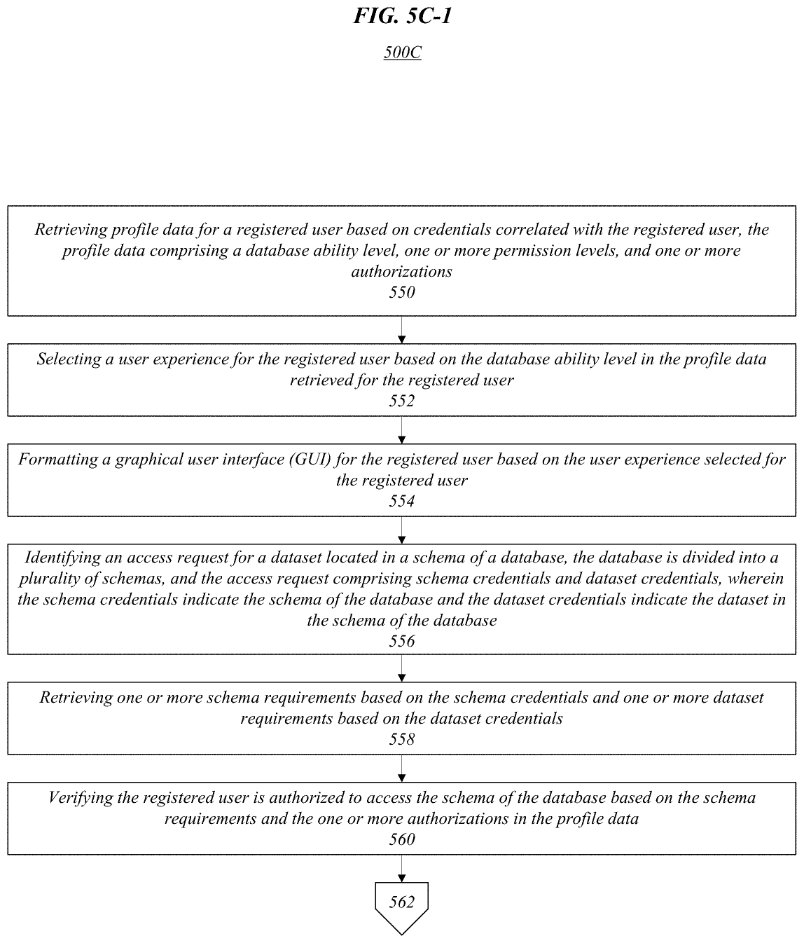

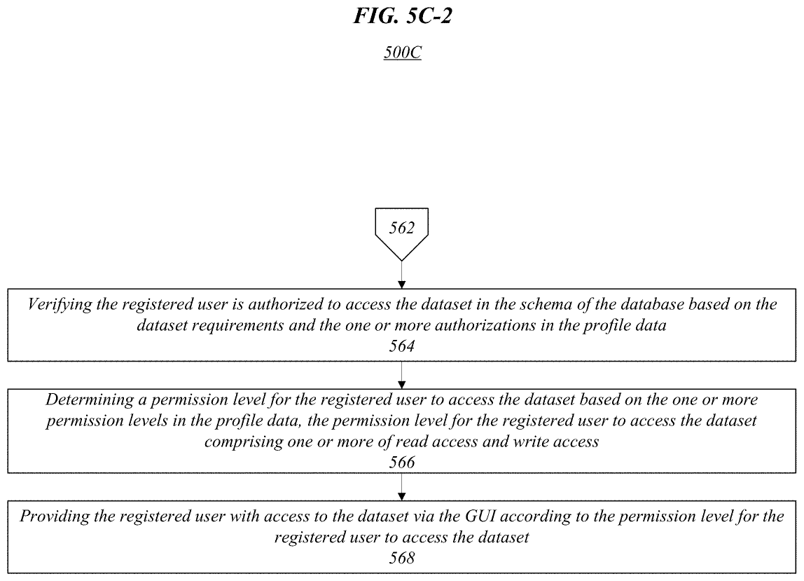

FIG. 5B illustrates a second logic flow provided to describe exemplary steps that may be performed according to one or more embodiments described herein. In flow 500B, based on the identification of the login of a registered user, the registered user may be provided access to a dataset according to the user's permission level. Embodiments are not limited in this context.

In block 530, the login of a registered user may be identified based on receipt of credentials correlated with the registered user.

In block 532, profile data for the registered user may be retrieved based on receipt of credentials correlated with the registered user, the profile data comprising one or more permission levels and one or more authorizations.

In block 534, an access request for a dataset located in a schema of a database may be identified, wherein the database is divided into a plurality of schemas, and the access request comprising schema credentials and dataset credentials, wherein the schema credentials indicate the schema of the database and the dataset credentials indicate the dataset in the schema of the database.

In block 536, one or more schema requirements may be retrieved based on the schema credentials and one or more dataset requirements based on the dataset credentials.

In block 538, the registered user may be verified as being authorized to access the schema of the database based on the schema requirements and the one or more authorizations in the profile data.

In block 540, the registered user may be verified as being authorized to access the dataset in the schema of the database based on the dataset requirements and the one or more authorizations in the profile data.

In block 542, a permission level may be determined for the registered user to access the dataset based on the one or more permission levels in the profile data, the permission level for the registered user to access the dataset comprising one or more of read access and write access.

In block 544, the registered user may be provided with access to the dataset via a graphical user interface (GUI) according to the permission level for the registered user to access the dataset.

FIGS. 5C-1 and 5C-2 illustrate a third logic flow provided to describe exemplary method steps that may be performed according to one or more embodiments described herein. As shown in flow 500C, based on profile data for a registered user, a user may be verified as being authorized to access aspects of a dataset and the user may be provided with access to the dataset. Embodiments are not limited in this context.

The step of block 550 comprises retrieving profile data for a registered user based on credentials correlated with the registered user, the profile data comprising a database ability level, one or more permission levels, and one or more authorizations.

The step of block 552 comprises selecting a user experience for the registered user based on the database ability level in the profile data retrieved for the registered user.

The step of block 554 comprises formatting a graphical user interface (GUI) for the registered user based on the user experience selected for the registered user.

The step of block 556 comprises identifying an access request for a dataset located in a schema of a database, the database divided into a plurality of schemas, and the access request comprising schema credentials and dataset credentials, wherein the schema credentials indicate the schema of the database and the dataset credentials indicate the dataset in the schema of the database.

The step of block 558 comprises retrieving one or more schema requirements based on the schema credentials and one or more dataset requirements based on the dataset credentials.

The step of block 560 comprises verifying the registered user is authorized to access the schema of the database based on the schema requirements and the one or more authorizations in the profile data.

Block 562 represents a continuation of the logic flow 500C from FIG. 5C-1 to FIG. 5C-2.

The step of block 564 comprises verifying the registered user is authorized to access the dataset in the schema of the database based on the dataset requirements and the one or more authorizations in the profile data.

The step of block 566 comprises determining a permission level for the registered user to access the dataset based on the one or more permission levels in the profile data, the permission level for the registered user to access the dataset comprising one or more of read access and write access.

The step of block 568 comprises providing the registered user with access to the dataset via the GUI according to the permission level for the registered user to access the dataset.

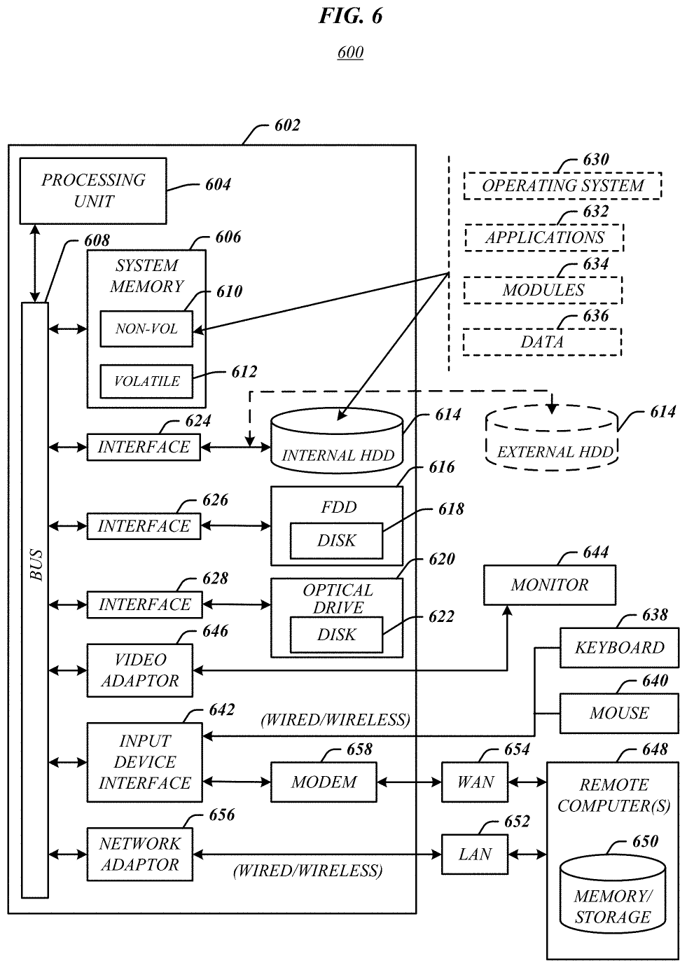

FIG. 6 illustrates an embodiment of an exemplary computing architecture 600 that may be suitable for implementing various embodiments as previously described. In various embodiments, the computing architecture 600 may comprise or be implemented as part of an electronic device. In some embodiments, the computing architecture 600 may be representative, for example, of one or more component described herein. In some embodiments, computing architecture 600 may be representative, for example, of a computing device that implements or utilizes one or more of database controller 104, access manager 216, data manager 218, and/or one or more techniques described herein. Embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 604.

The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and/or volatile memory 612. In some embodiments, system memory 606 may include main memory. A basic input/output system (BIOS) can be stored in the non-volatile memory 610.

The computer 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and Institute of Electrical and Electronics Engineers (IEEE) 694 interface technologies. In various embodiments, these types of memory may not be included in main memory or system memory.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include or implement, for example, the various techniques, applications, and/or components described herein.

A user can enter commands and information into the computer 602 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 604 through an input device interface 642 that is coupled to the system bus 608, but can be connected by other interfaces such as a parallel port, IEEE 994 serial port, a game port, a USB port, an IR interface, and so forth.

A monitor 644 or other type of display device is also connected to the system bus 608 via an interface, such as a video adaptor 646. The monitor 644 may be internal or external to the computer 602. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. In various embodiments, one or more migrations may occur via the networked environment. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

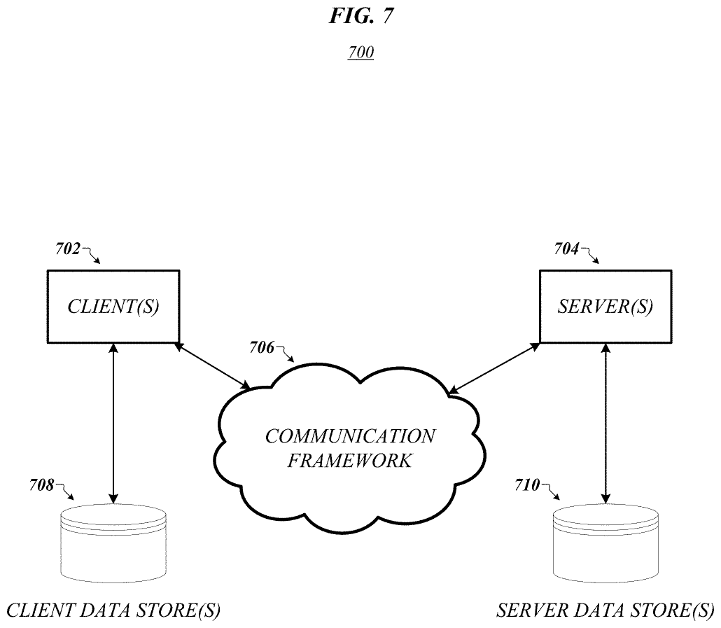

FIG. 7 illustrates a block diagram of an exemplary communications architecture 700 suitable for implementing various embodiments as previously described, such as virtual machine migration. The communications architecture 700 includes various common communications elements, such as a transmitter, receiver, transceiver, radio, network interface, baseband processor, antenna, amplifiers, filters, power supplies, and so forth. The embodiments, however, are not limited to implementation by the communications architecture 700.

As shown in FIG. 7, the communications architecture 700 comprises includes one or more clients 702 and servers 704. In some embodiments communications architecture may include or implement one or more portions of components, applications, and/or techniques described herein. The clients 702 and the servers 704 are operatively connected to one or more respective client data stores 708 and server data stores 710 that can be employed to store information local to the respective clients 702 and servers 704, such as cookies and/or associated contextual information. In various embodiments, any one of servers 704 may implement one or more of logic flows or operations described herein in conjunction with storage of data received from any one of clients 702 on any of server data stores 710. In one or more embodiments, one or more of client data store(s) 708 or server data store(s) 710 may include memory accessible to one or more portions of components, applications, and/or techniques described herein.

The clients 702 and the servers 704 may communicate information between each other using a communication framework 706. The communications framework 706 may implement any well-known communications techniques and protocols. The communications framework 706 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 706 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1900 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 702 and the servers 704. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various users or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

1. An apparatus, comprising:
a processor; and
memory comprising instructions that when executed by the processor cause the processor to:
identify a login of a registered user based on receipt of credentials correlated with the registered user;
retrieve profile data for the registered user based on the credentials correlated with the registered user, the profile data comprising a database ability level, one or more permission levels, and one or more authorizations;
select a user experience for the registered user based on the database ability level in the profile data retrieved for the registered user;
format a graphical user interface (GUI) for the registered user based on the user experience selected for the registered user;
identify an access request for a dataset located in a schema of a database, the database divided into a plurality of schemas, and the access request comprising schema credentials and dataset credentials, wherein the schema credentials indicate the schema of the database and the dataset credentials indicate the dataset in the schema of the database;
retrieve one or more schema requirements based on the schema credentials and one or more dataset requirements based on the dataset credentials;
verify the registered user is authorized to access the schema of the database based on the schema requirements and the one or more authorizations in the profile data;
verify the registered user is authorized to access the dataset in the schema of the database based on the dataset requirements and the one or more authorizations in the profile data;
determine a permission level for the registered user to access the dataset based on the one or more permission levels in the profile data, the permission level for the registered user to access the dataset comprising one or more of read access and write access; and
provide the registered user with access to the dataset via the GUI according to the permission level for the registered user to access the dataset.

2. The apparatus of claim 1, the dataset comprising a first dataset with a first table and the memory comprising instructions that when executed by the processor cause the processor to join a portion of the first table to a portion of a second table in a second dataset in the database.

3. The apparatus of claim 2, the first dataset and the second dataset comprised in different schemas of the database.

4. The apparatus of claim 2, the memory comprising instructions that when executed by the processor cause the processor to intermittently synchronize the portion of the first table with the portion of the second table to join the portion of the first table to the portion of the second table.

5. The apparatus of claim 1, the memory comprising instructions that when executed by the processor cause the processor to enable the registered user, via the GUI, to create another dataset and store the other dataset in the database.

6. The apparatus of claim 1, the memory comprising instructions that when executed by the processor cause the processor to:
track access to the dataset by the registered user; and
generate one or more access records associated with the registered user based on tracked access to the dataset by the registered user, wherein each of the one or more access records comprise metadata, wherein a respective metadata associates a respective access record with the registered user.

7. The apparatus of claim 6, at least one of the one or more access records comprising a snapshot of the dataset, wherein the at least one access record comprising the snapshot of the dataset was generated in association with an edit to contents of the dataset by the registered user.

8. At least one non-transitory computer-readable medium comprising a set of instructions that, in response to being executed by a processor circuit, cause the processor circuit to:
identify a login of a registered user based on receipt of credentials correlated with the registered user;
retrieve profile data for the registered user based on receipt of credentials correlated with the registered user, the profile data comprising one or more permission levels and one or more authorizations;
identify an access request for a dataset located in a schema of a database, the database is divided into a plurality of schemas, and the access request comprising schema credentials and dataset credentials, wherein the schema credentials indicate the schema of the database and the dataset credentials indicate the dataset in the schema of the database;
retrieve one or more schema requirements based on the schema credentials and one or more dataset requirements based on the dataset credentials;
verify the registered user is authorized to access the schema of the database based on the schema requirements and the one or more authorizations in the profile data;
verify the registered user is authorized to access the dataset in the schema of the database based on the dataset requirements and the one or more authorizations in the profile data;
determine a permission level for the registered user to access the dataset based on the one or more permission levels in the profile data, the permission level for the registered user to access the dataset comprising one or more of read access and write access; and
provide the registered user with access to the dataset via a graphical user interface (GUI) according to the permission level for the registered user to access the dataset.

9. The at least one non-transitory computer-readable medium of claim 8, the profile data comprising a database ability level, and the at least one non-transitory computer-readable medium comprising instructions that, in response to being executed by the processor circuit, cause the processor circuit to select a user experience for the registered user based on the database ability level in the profile data retrieved for the registered user.

10. The at least one non-transitory computer-readable medium of claim 9, comprising instructions that, in response to being executed by the processor circuit, cause the processor circuit to format the GUI for the registered user based on the user experience selected for the registered user.

11. The at least one non-transitory computer-readable medium of claim 8, the dataset comprising a first dataset with a first table, and the at least one non-transitory computer-readable medium comprising instructions that, in response to being executed by the processor circuit, cause the processor circuit to join a portion of the first table to a portion of a second table in a second dataset in the database.

12. The at least one non-transitory computer-readable medium of claim 8, comprising instructions that, in response to being executed by the processor circuit, cause the processor circuit to enable the registered user, via the GUI, to create another dataset and store the other dataset in the database.

13. The at least one non-transitory computer-readable medium of claim 8, comprising instructions that, in response to being executed by the processor circuit, cause the processor circuit to:
track access to the dataset by the registered user; and
generate one or more access records associated with the registered user based on tracked access to the dataset by the registered user, wherein each of the one or more access records comprise metadata, wherein a respective metadata associates a respective access record with the registered user.

14. The at least one non-transitory computer-readable medium of claim 13, at least one of the one or more access records comprising a snapshot of the dataset, wherein the at least one access record comprising the snapshot of the dataset was generated in association with an edit to contents of the dataset by the registered user.

15. A computer-implemented method, comprising:
retrieving profile data for a registered user based on credentials correlated with the registered user, the profile data comprising a database ability level, one or more permission levels, and one or more authorizations;
selecting a user experience for the registered user based on the database ability level in the profile data retrieved for the registered user;
formatting a graphical user interface (GUI) for the registered user based on the user experience selected for the registered user;
identifying an access request for a dataset located in a schema of a database, the database is divided into a plurality of schemas, and the access request comprising schema credentials and dataset credentials, wherein the schema credentials indicate the schema of the database and the dataset credentials indicate the dataset in the schema of the database;
retrieving one or more schema requirements based on the schema credentials and one or more dataset requirements based on the dataset credentials;
verifying the registered user is authorized to access the schema of the database based on the schema requirements and the one or more authorizations in the profile data;
verifying the registered user is authorized to access the dataset in the schema of the database based on the dataset requirements and the one or more authorizations in the profile data;
determining a permission level for the registered user to access the dataset based on the one or more permission levels in the profile data, the permission level for the registered user to access the dataset comprising one or more of read access and write access; and
providing the registered user with access to the dataset via the GUI according to the permission level for the registered user to access the dataset.

16. The computer-implemented method of claim 15, the dataset comprising a first dataset with a first table and comprising joining a portion of the first table to a portion of a second table in a second dataset in the database.

17. The computer-implemented method of claim 16, the first dataset and the second dataset comprised in different schemas of the database.

18. The computer-implemented method of claim 16, comprising intermittently synchronizing the portion of the first table with the portion of the second table to join the portion of the first table to the portion of the second table.

19. The computer-implemented method of claim 15, comprising enabling the registered user, via the GUI, to create another dataset and store the other dataset in the database.

20. The computer-implemented method of claim 15, comprising:
tracking access to the dataset by the registered user; and
generating one or more access records associated with the registered user based on tracked access to the dataset by the registered user, wherein each of the one or more access records comprise metadata, wherein a respective metadata associates a respective access record with the registered user.
